(19) United States
(12) Patent Application Publication
(10) Pub. No.: US 2024/0412111 A1
(43) Pub. Date: Dec. 12, 2024

(54) INFORMATION PROCESSING APPARATUS, NON-TRANSITORY COMPUTER-READABLE STORAGE MEDIUM, METHOD

(71) Applicant: AI inside Inc., Tokyo (JP)

(72) Inventor: Weiming HU, Tokyo (JP)

(73) Assignee: AI inside Inc., Tokyo (JP)

(21) Appl. No.: 18/808,287

(22) Filed: Aug. 19, 2024

Related U.S. Application Data
(63) Continuation of application No. PCT/JP2023/002958, filed on Jan. 31, 2023.

(30) Foreign Application Priority Data
Mar. 18, 2022 (JP) 2022-043796

(51) Int. Cl. G06N 20/00

(52) U.S. Cl. CPC G06N 20/00

(57) ABSTRACT

An information processing apparatus including processing circuitry configured to accept a plurality of learned models selected by a user, and a generating step of generating an information processing process by combining the plurality of learned models accepted in the model accepting step.

### CROSS-REFERENCE TO RELATED APPLICATIONS

This application is based upon and claims the benefit of priority from the prior Japanese Patent Application No. JP2022-043796, filed Mar. 18, 2022, and the PCT Patent Application No. PCT/JP2023/2958, filed Jan. 31, 2023 the entire contents of which are incorporated herein by reference.

### FIELD

The present disclosure relates to a information processing apparatus, a non-transitory computer-readable storage medium, and a method.

### BACKGROUND

Coordinating systems that perform data coordination among a plurality of applications are known.

Conventional system discloses an easy-to-use, highly versatile application coordinating system.

Conventional system discloses an information processing device that can implement various combinations of software modules without imposing a particular burden on a user and can carry out various processes.

In a case where an operating process is to be implemented with software, it is difficult to coordinate the software, a development environment, an infrastructure, and the like to implement the operating process.

Hence, the present disclosure is made to solve the above problem, and an object of the present disclosure is to provide a technique of flexibly implementing an operating process for each user as a software service.

### BRIEF DESCRIPTION OF DRAWINGS

FIG. 1 is a block diagram illustrating a functional configuration of an information processing system 1.

FIG. 2 is a block diagram illustrating a functional configuration of a server 10.

FIG. 3 is a block diagram illustrating a functional configuration of a user terminal 20.

FIG. 4 is a diagram illustrating a data structure of a user table 1012.

FIG. 5 is a diagram illustrating a data structure of a workflow table 1013.

FIG. 6 is a diagram illustrating a data structure of a model master 1021.

FIG. 7 is a diagram illustrating a data structure of a function master 1022.

FIG. 8 is a diagram illustrating a data structure of a screen master 1023.

FIG. 9 is a flowchart illustrating operation of a workflow creation process.

FIG. 10 is a screen example illustrating a selection of learned models in the workflow creation process.

FIG. 11 is a screen example illustrating a selection of functions in the workflow creation process.

FIG. 12 is a screen example illustrating a setting of an input screen in the workflow creation process.

FIG. 13 is a screen example illustrating a setting of a notification screen in the workflow creation process.

FIG. 14 is a block diagram illustrating a basic hardware configuration of a computer 90.

### DETAILED DESCRIPTION

In general, according to one embodiment, a program to be executed by a computer including a processor and a storage unit, the program causing the processor to execute: a model accepting step of accepting a plurality of learned models selected by a user; and a generating step of generating an information processing process by combining the plurality of learned models accepted in the model accepting step.

An embodiment of the present disclosure will be described below with reference to the drawings. In all of the drawings used for illustrating the embodiment, the same constituent components are denoted by the same reference characters, and repetitive descriptions thereof will be omitted. The embodiment described below shall not be construed as unreasonably limiting the content of the present disclosure described in the claims. In addition, all of the constituent components described in the embodiment are not necessarily essential for the present disclosure. Each of the drawings is schematic and is not necessarily an exact illustration.

### <Configuration of Information Processing System 1>

An information processing system 1 according to the present disclosure is an information processing system that combines learned models, functions, screens, and the like to create and provide an information processing process called a workflow to execute a series of information processes on input data.

The information processing system 1 includes information processing devices including a server 10, user terminals 20A, 20B, 20C, . . . that are connected together over a network N.

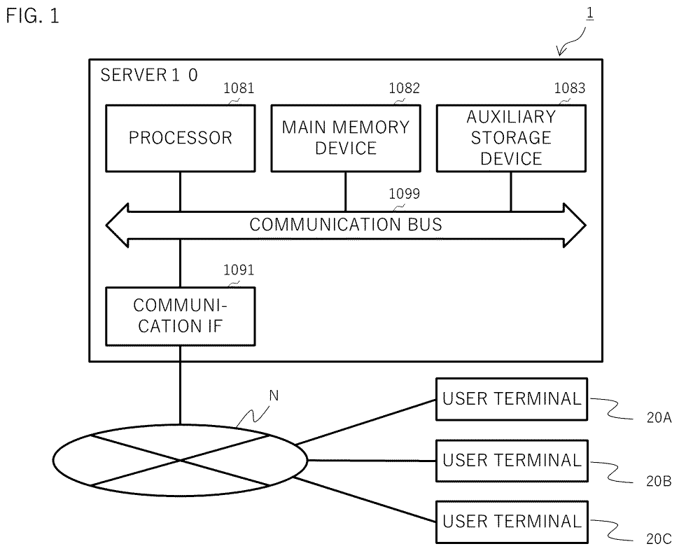

FIG. 1 is a block diagram illustrating a functional configuration of the information processing system 1.

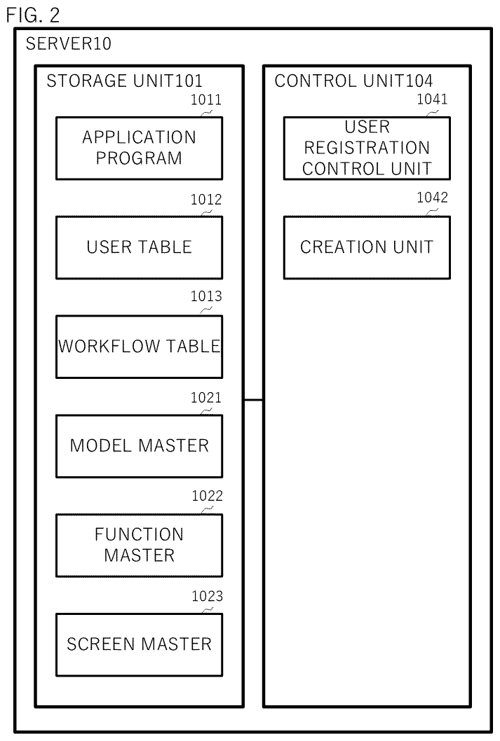

FIG. 2 is a block diagram illustrating a functional configuration of the server 10.

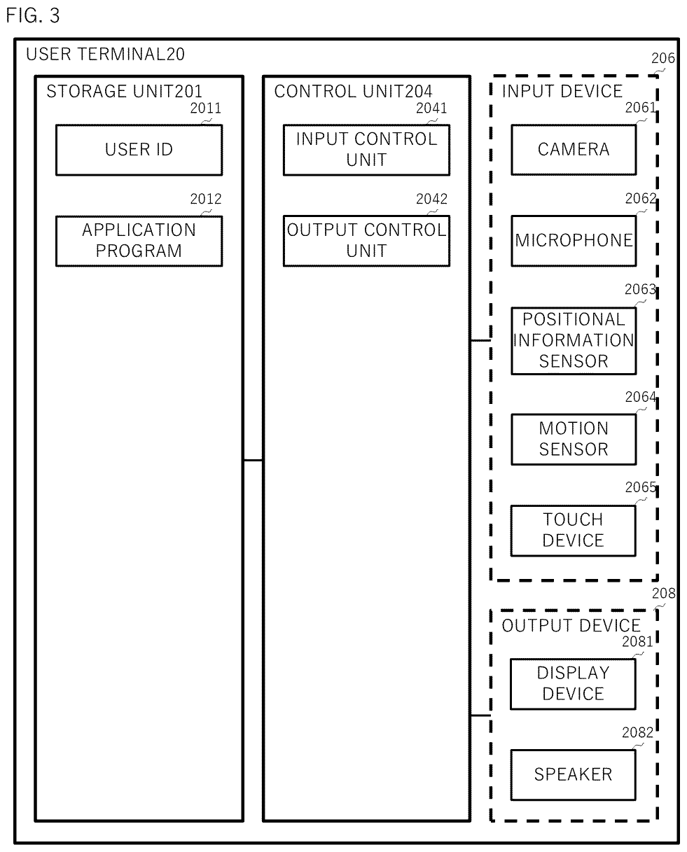

FIG. 3 is a block diagram illustrating a functional configuration of a user terminal 20.

The information processing devices are each configured with a computer that includes an arithmetic unit and a storage device. A basic hardware configuration of the computer and a basic functional configuration of the computer implemented by the hardware configuration will be described later. For the server 10 and the user terminal 20, repetitive description of the basic hardware configuration of the computer and the basic functional configuration of the computer described later will be omitted.

### <Configuration of Server 10>

The server 10 is an information processing device that provides a workflow creation processing service described later.

The server 10 includes a storage unit 101 and a control unit 104.

### <Configuration of Storage Unit 101 of Server 10>

The storage unit 101 of the server 10 includes an application program 1011, a user table 1012, a workflow table 1013, a model master 1021, a function master 1022, and a screen master 1023.

The application program 1011 is a program that causes the control unit 104 of the server 10 to function as functional units.

The application program 1011 includes an application such as a web browser application.

The user table 1012 is a table that stores and manages information on member users (hereinafter, users) who use the service. When a user performs registration for using the service, information on the user is stored in a new record of the user table 1012. Thus, the user can use the service according to the present disclosure.

The user table 1012 is a table including a user ID column and a user name column, where the user ID column is a primary key.

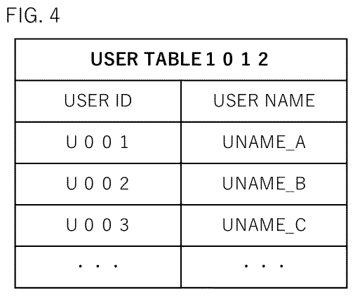

FIG. 4 is a diagram illustrating a data structure of the user table 1012.

The user ID column is an item that stores user identification information for identifying a user. The user identification information is an item to which a value unique to each piece of user information is set.

The user name column is an item that stores a full name of a user. As a user name, any character string such as a nickname may be set rather than a full name.

The workflow table 1013 is a table that stores and manages information on a workflow (workflow information).

The workflow table 1013 is a table including a workflow ID column, a user ID column, and a workflow data column, where the workflow ID column is a primary key.

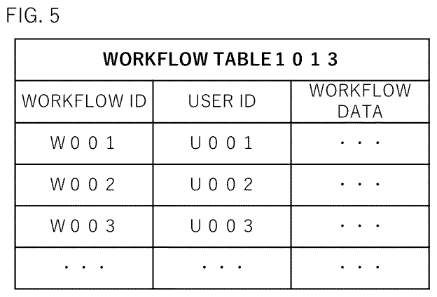

FIG. 5 is a diagram illustrating a data structure of the workflow table 1013.

The workflow ID column is an item that stores workflow identification information for identifying a workflow. The workflow identification information is an item to which a value unique to each piece of workflow information is set.

The user ID column is an item that stores user identification information for identifying a user.

The workflow data column is an item that stores information about a workflow that implements a series of processes. Workflow data is stored being associated with a user ID of a workflow creator.

The workflow data is an item that stores information on pieces of input data or output t data of pieces of model information, function information, screen information, and the like that are connected together. Specifically, the workflow data stores a plurality of model IDs, a plurality of function IDs, a plurality of screen IDs, and information on connections among pieces of input data and output data of the model IDs, function IDs, and screen IDs.

For example, the workflow data stores information representing that output data of a model having a model ID “M001” is input as input data to a function ID “F001.”

The model master 1021 is a table that stores and manages pieces of information about models (pieces of model information).

The model master 1021 is a table including a model ID column, a model name column, a model data column, an input data type column, an input roll column, an output data type column, and an output roll column, where the model ID column is a primary key.

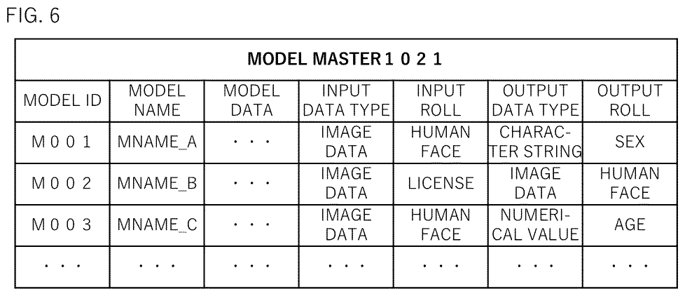

FIG. 6 is a diagram illustrating a data structure of the model master 1021.

The model ID column is an item that stores model identification information for identifying a model. The model identification information is an item to which a value unique to each piece of model information is set.

The model name column is an item that stores a name of a model. As a model name, any character string can be set.

The model data column is an item that stores data of a learned model. Model data is an inference model that receives, as input data, data of a class specified with an input data type item and an input roll item and outputs (infers) data of a class specified with an output data type item and an output roll item.

The model data is, for example, a type of an inference model, a machine learning model, an artificial intelligence model, a deep learning model, and the like.

The model data need not be a single learned model and may be implemented by switching a plurality of independent learned models from one to another.

As an example of the model data, a deep learning model implemented with a deep neural network in deep learning will be described. The model data need not necessarily be a deep learning model. The model data may be any machine learning model or artificial intelligence model.

The input data type column is an item that stores a data type of data input into model data. Specifically, the data type includes types such as a numerical value, character string, date, image, voice, and video.

The input roll column is an item that stores roll information, which defines a role of data input into model data. For example, in a case of character string data, a roll includes full name, sex (M, F, etc.), another name, nickname, trade name, product ID, or the like. In a case of numerical data, the roll includes age, category, or the like. In a case of image data, the roll stores a type of an object being an imaging target included in the image data such as document, identification card, driver's license, health insurance card, road, tire, and or human face.

In the present disclosure, an input data type and an input roll will be collectively called input data constraint.

The output data type column is an item that stores a data type of data output from model data.

The output roll column is an item that stores roll information, which defines a role of data output from model data.

In the present disclosure, an output data type and an output roll will be collectively called an output data constraint.

The function master 1022 is a table that stores and manages information about a function (function information).

The function master 1022 is a table including a function ID column, a function name column, a function data column, an input data type column, and an output data type column, where the function ID column is a primary key.

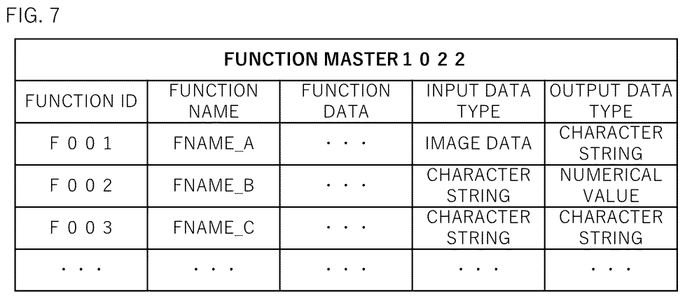

FIG. 7 is a diagram illustrating a data structure of the function master 1022.

The function ID column is an item that stores function identification information for identifying a function. The function identification information is an item to which a value unique to each piece of function information is set.

The function name column is an item that stores a name of a function. As a function name, any character string can be set.

The function data column is an item that stores data of a function (function) that implements a predetermined process. Function data is an inference model that receives, as input data, data having an input data type and outputs (infers), as output data, data having an output data type.

The function data is a type of a function that is defined in any programming language. The function data includes any program, application, or the like that converts input data to output data according to specific rules.

The input data type column is an item that stores a data type of data input into function data.

The output data type column is an item that stores a data type of data output from function data.

The screen master 1023 is a table that stores and manages information about a screen (screen information).

The screen master 1023 is a table including a screen ID column and a screen type column, where the screen ID column is a primary key.

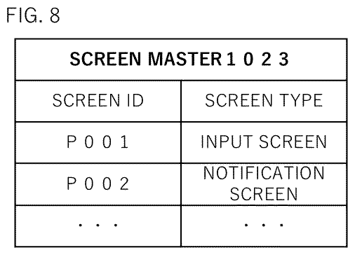

FIG. 8 is a diagram illustrating a data structure of the screen master 1023.

The screen ID column is an item that stores screen identification information for identifying a screen. The screen identification information is an item to which a value unique to each piece of screen information is set.

The screen type column is an item that stores a type of a screen. The screen type includes input screen, notification screen, and the like. The input screen is a screen on which a user inputs input data for model data or function data. The notification screen is a screen on which a user is provided with notification of output data of the input screen, the model data, and the function data.

### <Configuration of Control Unit 104 of Server 10>

The control unit 104 of the server 10 includes a user registration control unit 1041 and a creation unit 1042. The control unit 104 implements the functional units by executing the application program 1011 stored in the storage unit 101.

The user registration control unit 1041 performs a process of storing, in the user table 1012, information on a user who desires to use the service according to the present disclosure.

The information stored in the user table 1012 is input by a user by opening, on any information processing terminal, a web page or the like operated by a service provider, inputting the information on a predetermined entry form, and transmitting the information to the server 10. Receiving the information, the user registration control unit 1041 stores the information in a new record of the user table 1012, thus completing user registration. This enables the user stored in the user table 1012 to use the service.

Before the registration of user information to the user table 1012 by the user registration control unit 1041, the service provider may perform a predetermined screening to control whether to permit a user to use the service.

A user ID may be any character string or number that can identify a user. Any character string or number desired by the user may be set, or any character string or number may be automatically set by the user registration control unit 1041.

The creation unit 1042 executes a workflow creation process. This will be described later in detail.

### <Configuration of User Terminal 20>

The user terminal 20 is an information processing device that is operated by a user who uses the service. The user terminal 20 may be, for example, a portable terminal such as a smartphone or a tablet computer, a desktop personal computer (PC), or a laptop PC. Alternatively, the user terminal may be a wearable terminal such as a head mount display (HMD) or a smartwatch.

The user terminal 20 includes a storage unit 201, a control unit 204, an input device 206, and an output device 208.

### <Configuration of Storage Unit 201 of User Terminal 20>

The storage unit 201 of the user terminal 20 includes a user ID 2011 and an application program 2012.

The user ID 2011 is an account ID of a user. The user transmits the user ID 2011 from the user terminal 20 to the server 10. The server 10 identifies the user based on the user ID 2011 and provides the service according to the present disclosure to the user. Note that the user ID 2011 includes information such as a session ID that is temporarily given by the server 10 to identify the user using the user terminal 20.

The application program 2012 may be stored in advance in the storage unit 201 or may be downloaded via a communication IF from a web server or the like operated by the service provider.

The application program 2012 includes an application such as a web browser application.

The application program 2012 includes an interpreted programming language to be executed on the web browser application stored in the user terminal 20, such as JavaScript®.

### <Configuration of Control Unit 204 of User Terminal 20>

The control unit 204 of the user terminal 20 includes an input control unit 2041 and an output control unit 2042. The control unit 204 implements functional units by executing the application program 2012 stored in the storage unit 201.

### <Configuration of Input Device 206 of User Terminal 20>

The input device 206 of the user terminal 20 includes a camera 2061, a microphone 2062, a positional information sensor 2063, a motion sensor 2064, and a touch device 2065.

### <Configuration of Output Device 208 of User Terminal 20>

The output device 208 of the user terminal 20 includes a display device 2081 and a speaker 2082.

### <Operation of Information Processing System 1>

Processes by the information processing system 1 will be described below.

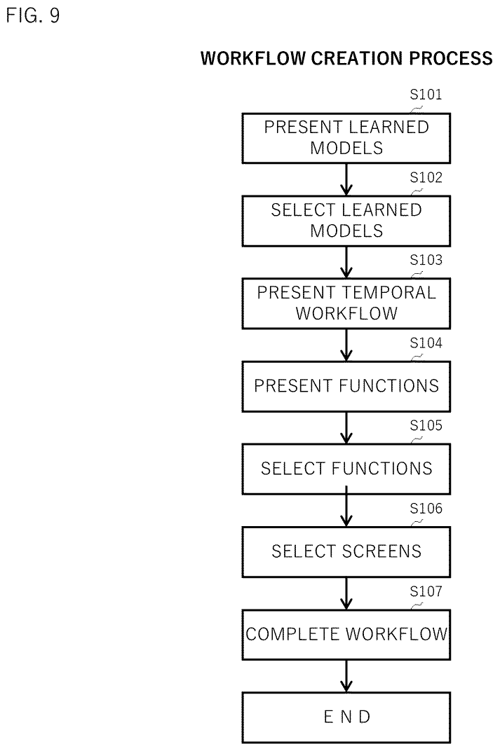

FIG. 9 is a flowchart illustrating operation of the workflow creation process.

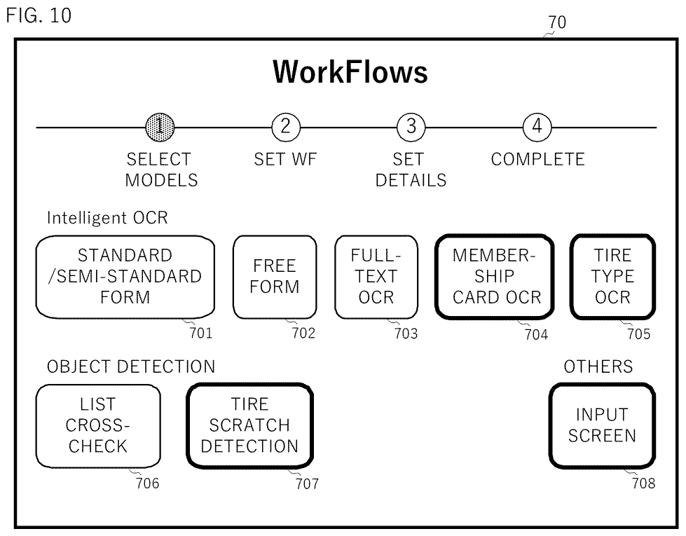

FIG. 10 is a screen example illustrating a selection of learned models in the workflow creation process.

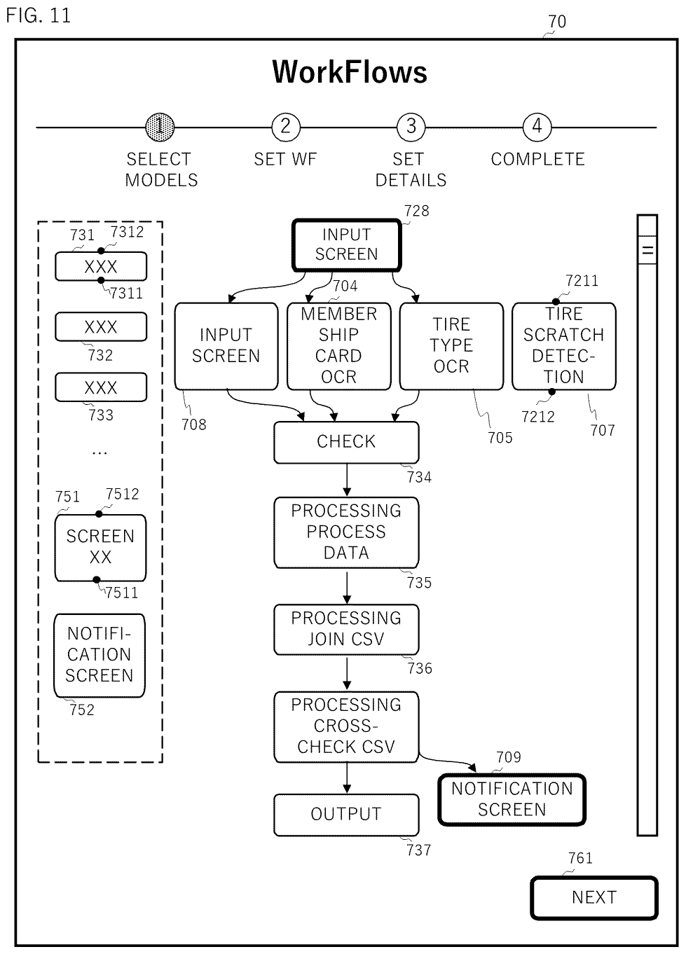

FIG. 11 is a screen example illustrating a selection of functions in the workflow creation process.

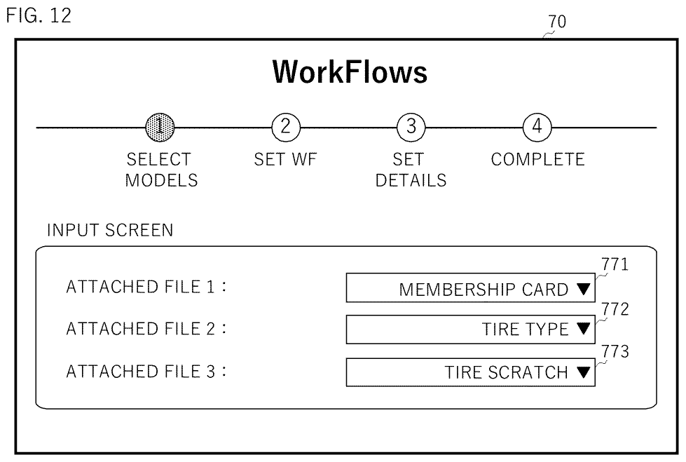

FIG. 12 is a screen example illustrating a setting of an input screen in the workflow creation process.

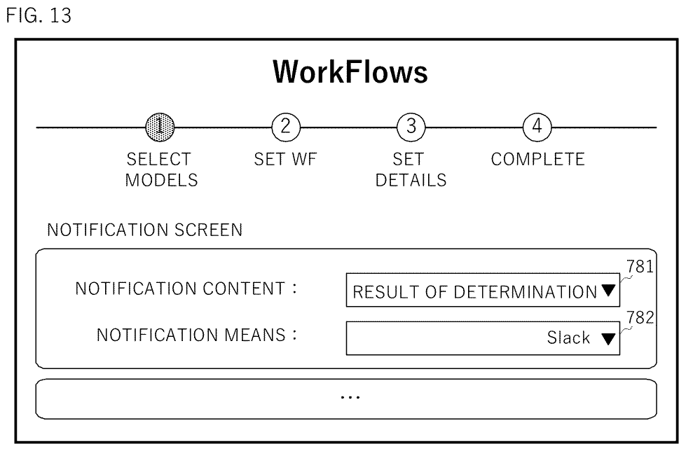

FIG. 13 is a screen example illustrating a setting of a notification screen in the workflow creation process.

### <Workflow Creation Process>

The workflow creation process is a process of combining learned models, functions, screens, and the like to create and generate an information processing process called a workflow to execute a series of information processes on input data.

### <Outline of Workflow Creation Process>

The workflow creation process is a series of processes including presenting learned models to a user, accepting learned models selected by the user, presenting a temporal workflow based on the accepted learned models to the user, presenting functions to the user, accepting functions selected by the user, accepting a screen selected by the user, and creating a workflow that executes a series of information processes on input data.

### <Details of Workflow Creation Process>

Details of the workflow creation process will be described below.

In step S101, the creation unit 1042 of the server 10 presents a plurality of learned models to a user. Specifically, the creation unit 1042 of the server 10 refers to the model master 1021, obtains pieces of model information including model IDs and model names, and transmits the pieces of model information to the user terminal 20. The pieces of model information may include pieces of information on descriptions and the like of respective models.

The display device 2081 of the user terminal 20 presents, to a user, the model IDs and model names received from the server 10.

FIG. 10 is a screen example displayed on the display device 2081 of the user terminal 20. A screen 70 includes objects 701 to 707 representing pieces of model information, an object 708 representing an input screen, and a “Next” button 711.

In step S102, the creation unit 1042 of the server 10 executes a model accepting step of accepting a plurality of learned models selected by the user.

Selecting from among the objects 701 to 707 by operating the input device 206 or the like of the user terminal 20, the user can select pieces of model information corresponding to the selected objects. The user selects desired pieces of model information in accordance with a workflow that the user desires to create.

When the user desires to set an input screen for the selected pieces of model information, the user can select the object 708 for the input screen by operating the input device 206 or the like of the user terminal 20. Specifically, frame borders of the objects 704, 705, 707, and 708, which are selected objects, are displayed in bold lines, clearly indicating to the user that the objects are selected. After the user completes the selection of the desired pieces of model information, the user presses the “Next” button 711 by operating the input device 206 or the like of the user terminal 20. This causes the control unit 204 of the user terminal 20 to transmit, to the server 10, a request that includes the user ID 2011, model IDs included in the selected pieces of model information, and a screen ID of the selected input screen.

The creation unit 1042 of the server 10 receives and accepts the user ID 2011, the model IDs, and the screen ID included in the request.

In step S103, the creation unit 1042 of the server 10 executes a generating step of generating an information processing process by combining the plurality of learned models accepted in the model accepting step.

Specifically, based on the model IDs and the screen ID included in the received request, the creation unit 1042 of the server 10 creates a temporal workflow. The creation unit 1042 of the server 10 stores the user ID 2011 and the temporal workflow in a user ID item and a workflow data item of the workflow table 1013, respectively.

In step S103, the generating step is a step that can generate an information processing process including a combination in which output data of a first learned model included in the plurality of learned models serves as input data of a second learned model included in the plurality of learned models. An output data constraint including an output data type and an output roll of the first learned model is included in an input data constraint including an input data type and an input roll of the second learned model.

Specifically, assume a case where the received model IDs include a first model ID and a second model ID. The creation unit 1042 of the server 10 searches items in the model ID column of the model master 1021 based on the first model ID and the second model ID to obtain a first input constraint including a first input data type and a first input roll of a first model, a first output constraint including a first output data type and a first output roll of the first model, a second input constraint including a second input data type of a second model, and a second output constraint including a second input roll, a second output data type, and a second output roll of the second model.

The creation unit 1042 of the server 10 compares the first output constraint with the second input constraint. In a case where the first output constraint is included in the second input constraint, the creation unit 1042 associates the first model and the second model with each other in such a manner that output data of the first model serves as input data of the second model, and stores the first model and the second model as the temporal workflow.

The case where the first output constraint is included in the second input constraint is assumed to be a case where the first output data type is included in the second input data type, and the first output roll is included in the second input roll. Examples of the case include a case where the first output data type is image data, the second input data type is image data, the first output roll is human face, and the second input roll is human face. In addition, also in a case where, for example, the first output data type is image data, the second input data type is image data, the first output roll is license, and the second input roll is document, the first output roll can be considered to be included in the second input roll because license is a type of document. Note that an inclusion relationship between data types and an inclusion relationship between rolls may be defined in a dictionary database not illustrated or the like.

The creation unit 1042 of the server 10 compares the second output constraint with the first input constraint. In a case where the second output constraint is included in the first input constraint, the creation unit 1042 associates the first model and the second model with each other in such a manner that output data of the second model serves as input data of the first model, and stores the first model and the second model as the temporal workflow.

The case where the second output constraint is included in the first input constraint is assumed to be a case where the second output data type is included in the first input data type, and the second output roll is included in the first input roll. Examples of the case include a case where the second output data type is image data, the first input data type is image data, the second output roll is human face, and the first input roll is human face. In addition, also in a case where, for example, the second output data type is image data, the first input data type is image data, the second output roll is license, and the first input roll is document, the second output roll can be considered to be included in the first input roll because license is a type of document.

In step S103, the generating step may be a step that can generate an information processing process including a combination in which the output data of the first learned model included in the plurality of learned models serves as input data of a third learned model included in the plurality of learned models, and the first learned model may selectively output the output data to any one of the second learned model and the third learned model such that an output data constraint of the output data output from the first learned model is included in an input data constraint of the second learned model or the third learned model.

Specifically, assume a case where the received model IDs include a first model ID, a second model ID, and a third model ID. The creation unit 1042 of the server 10 searches items in the model ID column of the model master 1021 based on the first model ID, the second model ID, and the third model ID to obtain a first input constraint including a first input data type and a first input roll of a first model, a first output constraint including a first output data type and a first output roll of the first model, a second input constraint including a second input data type of a second model, a second output constraint including a second input roll, a second output data type, and a second output roll of the second model, a third input constraint including a third input data type of a third model, and a third output constraint including a third input roll, a third output data type, and a third output roll.

In this case, the first output constraint including the first output data type and the first output roll included in the first output constraint may include a plurality of output constraints. For example, the first output constraint may include an output constraint A in which its output data type and the output roll are image and license, respectively, and an output constraint B in which its output data type and its output roll are image and health insurance card, respectively.

The creation unit 1042 of the server 10 compares the output constraint A and output constraint B included in the first output constraint with the second input constraint. In a case where any one of the output constraint A and the output constraint B is included in the second input constraint, the creation unit 1042 associates the first model and the second model with each other in such a manner that output data of the first model serves as input data of the second model, and stores the first model and the second model as the temporal workflow.

The creation unit 1042 of the server 10 compares the output constraint A and output constraint B included in the first output constraint with the third input constraint. In a case where any one of the output constraint A and the output constraint B is included in the third input constraint, the creation unit 1042 associates the first model and the third model with each other in such a manner that output data of the first model serves as input data of the third model, and stores the first model and the third model as the temporal workflow.

In this case, in the workflow, the first learned model outputs output data to any one of the second learned model and the third learned model based on an output constraint including an output data type and output roll of the output data to be output. Specifically, in a case where the output constraint of the output data output from the first learned model is the output constraint A, the first learned model outputs the output data to the second learned model. In contrast, in a case where the output constraint of the output data output from the first learned model is the output constraint B, the first learned model outputs the output data to the third learned model.

For example, consider a case where the first learned model receives, as input data, image data including a document such as a license or health insurance card and outputs, as output data, either output data A having the output constraint A in which the output data type and the output roll are image and license, respectively, or output data B having the output constraint B in which the output data type and the output roll are image and health insurance card, respectively.

At this time, the output data A is input as input data for the second learned model. In contrast, the output data B is input as input data for the third learned model.

As seen from the above, in the present disclosure, even in a case where a learned model outputs output data according to an output constraint including a plurality of output data types and output rolls, the output data can be selectively input into a learned model that can receive the output data as its input data. Thus, it is possible to implement a workflow that executes a series of information processes in which a plurality of learned models are combined, without need of specialized engineering skills.

In a case where the first output constraint is not included in the second input constraint or a case where the second output constraint is not included in the first input constraint, the creation unit 1042 of the server 10 stores the first model and the second model in an item of the workflow data column as the temporal workflow without associating the first model and the second model with each other.

In step S104, the creation unit 1042 of the server 10 executes a presenting step of presenting, to a user, a plurality of functions that are selectable by the user, based on input data constraints including input data types and input rolls of the plurality of learned models accepted in the model accepting step or output data constraints including output data types and output rolls of the plurality of learned models.

Specifically, based on the model IDs accepted in step S102, the creation unit 1042 of the server 10 searches items in the model ID column of the model master 1021 to obtain an output constraint and an input constraint of each model ID.

The creation unit 1042 of the server 10 refers to the function master 1022, obtains pieces of function information including function IDs, function names, input data types, and output data types, and transmits the pieces of function information to the user terminal 20. The pieces of function information may include pieces of information on descriptions and the like of respective functions.

From among the obtained pieces of function information, the creation unit 1042 of the server 10 specifies, for each model ID, a piece of function information having an input data type that includes an output data type of an output constraint of the model ID and having an input data type that includes an output data type of an output constraint of the model ID. That is, for the pieces of model information specified with the model IDs accepted in step S102, the creation unit 1042 of the server 10 specifies pieces of function information that can output their respective pieces of input data or can receive their respective pieces of output data.

The creation unit 1042 of the server 10 refers to the screen master 1023, obtains pieces of screen information including screen IDs and screen names, and transmits the pieces of screen information to the user terminal 20. The pieces of screen information may include pieces of information on descriptions and the like of respective screens.

The creation unit 1042 of the server 10 transmits the specified pieces of function information to the user terminal 20. The display device 2081 of the user terminal 20 presents, to a user, the function IDs and function names received from the server 10.

FIG. 11 is a screen example displayed on the display device 2081 of the user terminal 20. A screen 70 includes objects and 707 representing pieces of model information, an object 708 representing an input screen, an object 709 representing a notification screen, objects 731 to 733 representing pieces of function information, objects 751 and 752 representing pieces of screen information, and a “Next” button 761. The objects 704, 705, and 707 representing the pieces of model information are pieces of model information constituting the temporal workflow.

In step S105, the creation unit 1042 of the server 10 executes a function accepting step of accepting a plurality of functions selected by the user. In the function accepting step, a step of accepting a plurality of functions selected by the user from among a plurality of functions selectable by the user that are presented in the presenting step is executed.

Specifically, selecting from among the objects 731 to 733 by operating the input device 206 or the like of the user terminal 20, the user can select pieces of function information corresponding to the selected objects. The user selects desired pieces of function information in accordance with a workflow that the user desires to create.

In step S105, in a generating step, a step of generating a workflow by combining the plurality of functions accepted in the function accepting step is executed.

For example, dragging and dropping an output node 7311 and input node 7312 of the object 731 representing one of the pieces of function information into an input node 7211 and output node 7212 of the object 707 representing one of the pieces of model information constituting the temporal workflow, respectively, by operating the input device 206 or the like of the user terminal 20, the user can connect output data and input data of the object 731 representing one of the pieces of function information to input data and output data of a learned model corresponding to the object 707 representing one of the pieces of model information, respectively. Note that the screen 70 may be configured such that the user's operation for the connection fails when a data type of the input data does not include a data type of the output data.

The object 731 representing one of the pieces of function information need not necessarily include the output node 7311 and the input node 7312. The object 731 may include only the output node 7311 or only the input node 7312.

As seen from the above, in the present disclosure, by connecting pieces of input data and output data of the objects 731 to 733 representing the pieces of function information to pieces of input data and output data of the objects 704, 705, and 707 representing the pieces of model information, the user can create an information processing process called a workflow that executes a series of information processes including the objects 735 to 737 representing the piece of function information.

In the present disclosure, a case where the pieces of function information are connected to the pieces of model information is described. However, the pieces of function information may be connected to pieces of function information, and the pieces of model information may be connected to pieces of model information.

Output data of a piece of model information may be output to a piece of model information or function information. Likewise, output data of a piece of function information may be output to a piece of function information or model information.

The creation unit 1042 of the server 10 stores the user ID 2011, and the selected pieces of function information and information about connection between the pieces of function information and the pieces of model information in items of the user ID column and workflow data column of the workflow table 1013, respectively.

In step S105, the generating step is a step that can generate an information processing process including a combination in which the output data of the first learned model included in the plurality of learned models serves as input data of a first function included in the plurality of functions. An output data type of the first learned model is included in an input data type of the first function.

Specifically, assume a case where the received model IDs include the first model ID, and the selected function IDs include a first function ID. Based on the first model ID, the creation unit 1042 of the server 10 searches items in the model ID column of the model master 1021 to obtain the first input data type and first output data type of the first model. Based on the first function ID, the creation unit 1042 of the server 10 searches items in the function ID column of the function master 1022 to obtain a third input data type and a third output data type of a first function.

The creation unit 1042 of the server 10 compares the first output data type with the third input data type. In a case where the first output data type is included in the third input data type, the creation unit 1042 associates the first model and the first function with each other in such a manner that the output data of the first model serves as the input data of the first function, and stores the first model and the first function as the temporal workflow.

Examples of the case include a case where the first output data type is image data, and the third input data type is image data.

In step S106, the creation unit 1042 of the server 10 executes a screen accepting step of accepting a plurality of screens selected by the user.

Specifically, selecting from among the objects 751 and 752 by operating the input device 206 or the like of the user terminal 20, the user can select pieces of screen information corresponding to the selected objects. The user selects desired pieces of screen information in accordance with the created workflow.

In step S106, the generating step includes a step of generating an information processing process including a combination in which pieces of output data of a first screen included in the plurality of screens serve as pieces of input data of the first learned model included in the plurality of learned models and a step of specifying, based on an input data constraint including an input data type and input roll of the first learned model, input fields included in a first input screen and data constraints including data types and rolls of the input fields.

When the user combines a plurality of learned models with an input screen, this sets input fields to the input screen in accordance with the output data types and output rolls of the learned models. Thus, it is possible to easily and flexibly create the input screen without complicated operations performed by the user.

For example, dragging and dropping an output node 7511 and input node 7512 of the object 751 representing one of the pieces of screen information into the input node 7211 and output node 7212 of the object 707 representing one of the pieces of model information constituting the temporal workflow, respectively, by operating the input device 206 or the like of the user terminal 20, the user can connect output data and input data of the object 751 representing one of the pieces of screen information to input data and output data of a learned model corresponding to the object 707 representing one of the pieces of model information, respectively.

In a case where the piece of the screen information is an input screen, the object 751 includes only the output node 7511 and does not include the input node 7512. In a case where the piece of the screen information is a notification screen, the object 751 includes only the input node 7512 and does not include the output node 7511.

As seen from the above, in the present disclosure, by connecting the output data of the object 751 representing one of the piece of screen information to the pieces of input data and output data of the objects 704, 705, and 707 representing the pieces of model information, the user can create an information processing process called a workflow that executes a series of information processes.

As seen from the above, in the present disclosure, by connecting pieces of input data and output data of the objects 751 and 752 representing the pieces of screen information to the pieces of input data and output data of the objects 704, 705, and 707 representing the pieces of model information and connecting the pieces of input data and output data of the objects 751 and 752 representing the pieces of screen information to the pieces of input data and output data of the objects 731 to 733 representing the pieces of function information, the user can create the information processing process called a workflow that executes a series of information processes.

In the present disclosure, a case where the pieces of screen information are connected to the pieces of model information is described. However, the pieces of screen information may be connected to pieces of screen information, and the pieces of screen information may be connected to pieces of function information.

That is, output data of a piece of screen information may be output to a piece of model information, function information, or screen information. Likewise, output data of a piece of model information, function information, or screen information may be output to a piece of screen information.

The creation unit 1042 of the server 10 stores the user ID 2011, and the selected pieces of screen information and information about connection between the pieces of screen information, the pieces of function information, and the pieces of model information in items of the user ID column and workflow data column of the workflow table 1013, respectively.

In the present disclosure, the pieces of function information are selected in step S105 before the pieces of screen information are selected in step S106. However, the pieces of screen information may be selected before the pieces of function information are selected, or the screen 70 may be configured to allow the user to freely select the pieces of function information and screen information.

That is, the user may create the workflow by freely combining the objects 731 to 733 representing the pieces of function information, the objects 751 and 752 representing the pieces of screen information, and the objects 704, 705, and 707 representing the pieces of model information.

FIG. 12 is a screen example illustrating a setting of an input screen in the workflow creation process. A screen 70 includes input fields 771, 772, and 773 that correspond to the input fields set by the user. On the display device 2081 of the user terminal 20, the input fields 771, 772, and 773 are set based on input data constraints or input data types of pieces of input data of the pieces of model information and function information that are connected to pieces of output data of the input screen. That is, the input fields 771, 772, and 773 are input fields based on input data types, input rolls and the like included in input data constraints of the pieces of model information and function information that are output destinations of pieces of input data of the input fields, and thus the user cannot input data of a type other than the input data types. That is, input constraints and input rules of the input fields 771, 772, and 773 are automatically set.

FIG. 13 is a screen example illustrating a setting of a notification screen in the workflow creation process. A screen 70 includes a notification setting columns 781 and 782 set by the user. Setting the notification setting columns 781 and 782 by operating the input device 206 or the like of the user terminal 20, the user can set input data and notification means to be notification targets. Specifically, by operating the input device 206 or the like of the user terminal 20, the user can select, as notification content, one or more pieces of output data to be the notification targets from among a plurality of pieces of output data of the pieces of model information and function information that are input into the notification screen. The user can select, as the notification means, mail, a chat tool such as Slack, SMS, or the like by operating the input device 206 or the like of the user terminal 20.

In step S107, in the generating step, a step of generating the information processing process by combining the plurality of learned models accepted in the model accepting step and the plurality of screens accepted in the screen accepting step is executed.

Specifically, based on the pieces of model information, function information, and screen information accepted in step S102, step S105, and step S106, the creation unit 1042 of the server 10 completes the creation of a workflow being a series of information processing processes in which their pieces of input data are connected to their pieces of output data.

Specifically, the creation unit 1042 of the server 10 connects final output data of the series of processes of the workflow data in the workflow table 1013 to the finish information or notification screen indicating a process of the workflow, thus completing the creation of the workflow table. The item in the workflow data column of the workflow table 1013 is updated with the completed workflow data, and the updated item is stored. This causes information about the completed workflow to be stored in the item in the workflow data column of the workflow table 1013.

The user inputs input data from the input screen of the workflow information stored in the item in the workflow data column of the workflow table 1013 and thus can obtain desired output data as output data of the workflow.

In the present disclosure, since the workflow, the learned model, functions, and input screen constituting the workflow are stored in the storage unit 101 of the server 10, the input data input into the workflow is subjected to the series of information processing processes included in the workflow without unnecessary communication between the server 10 and the user terminal 20 or the like, and the user can obtain the desired output data.

### Modification

On the screen 70 presented on the display device 2081 of the user terminal 20, by operating the input device 206 or the like of the user terminal 20, the user can cause the user terminal 20 to read another learned model, function, input screen, or the like and additionally any learned model, function, input screen or the like that the user has created with another information processing terminal or the like, and combine them with a created workflow, thus creating a new workflow.

In addition, selecting the objects 704, 705, and 707 representing the pieces of model information by operating the input device 206 or the like of the user terminal 20, the user can replace the selected pieces of model information with any learned model, function, input screen, or the like that the user has created with another information processing terminal or the like and causes the user terminal 20 to read.

This makes it possible to replace one or some of the learned models and the like included in the created workflow with the learned model created by the user himself or herself. Replacing part of the workflow already created, the user can create a new workflow without need of specialized engineering skills.

### <Basic Hardware Configuration of Computer>

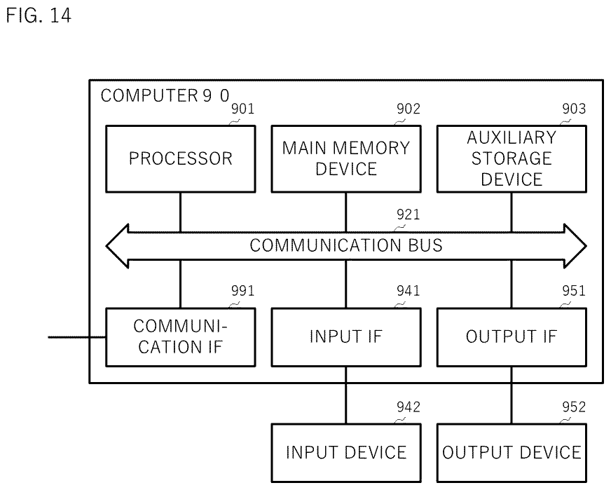

FIG. 14 is a block diagram illustrating a basic hardware configuration of a computer 90. The computer 90 includes at least a processor 901, a main memory device 902, an auxiliary storage device 903, and a communication interface (IF) 991. These components are mutually, electrically connected by a communication bus 921.

The processor 901 is a piece of hardware for executing a set of instructions written in a program. The processor 901 is constituted by an arithmetic unit, registers, peripheral circuits, and the like.

The main memory device 902 is for temporarily storing, for example, a program and data to be processed by the program or the like. The main memory device 902 is, for example, a volatile memory such as a dynamic random access memory (DRAM).

The auxiliary storage device 903 is a storage device for saving the data and the program. The auxiliary storage device 903 is, for example, a flash memory, a hard disc drive (HDD), a magneto-optical disk, a CD-ROM, a DVD-ROM, or a semiconductor memory.

The communication IF 991 is an interface through which the computer 90 inputs and outputs a signal to communicate with another computer via a network using a wired or wireless communications standard.

The network is constituted by, for example, various mobile telecommunications systems built with the Internet, a LAN, a wireless base station, and the like. Examples of the network include a 3G, 4G, or 5G mobile telecommunications system, long term evolution (LTE), a wireless network that enables a connection to the Internet via a predetermined access point (e.g., Wi-Fi®). In a case of a wireless connection, examples of communications protocols include Z-Wave®, ZigBee®, and Bluetooth®. In a case of a wired connection, the network includes a direct connection using a universal serial bus (USB) cable or the like.

Note that it is possible to implement the computer 90 virtually by mutually connecting, via a network, a plurality of computers 90 to which the entire or part of the hardware configuration is provided in a distributed manner. As seen from the above, the computer 90 is not only a concept including a computer 90 housed in a single housing or case but also a concept including a virtualized computer system.

### <Basic Functional Configuration of Computer 90>

A functional configuration of a computer that is implemented by the basic hardware configuration of the computer 90 (FIG. 14) will be described. The computer includes at least functional units of a control unit, a storage unit, and a communication unit.

Note that the functional units included in the computer 90 can be implemented by providing all, or one or some of the functional units are distributed among a plurality of computers 90 that are mutually connected via a network. The computer 90 is not only a concept including a single computer 90 but also a concept including a virtualized computer system.

The control unit is implemented by the processor 901 reading various programs stored in the auxiliary storage device 903, loading the programs onto the main memory device 902, and executing processing according to the programs. The control unit can implement functional units that perform various types of information processing in accordance with types of the programs. This implements the computer as an information processing device that performs information processing.

The storage unit is implemented by the main memory device 902 and the auxiliary storage device 903. The storage unit stores data, the various programs, and various databases. The processor 901 can keep a storage area corresponding to the storage unit in the main memory device 902 or the auxiliary storage device 903 according to the programs. The control unit can also cause the processor 901 to execute addition, update, and deletion processing on data stored in the storage unit according to the various programs.

The database refers to a relational database. The database is configured to manage tabular-form data sets that are structurally defined by rows and columns, called tables or masters, in association with one another. In a database, a table is called a table or master, a column of a table is called a column, and a row of a table is called a row. In a relational database, relations between tables and masters can be set so as to associate the tables and masters with one another.

In each table or master, a column that serves as a primary key for uniquely specifying a record is usually set. However, setting a primary key to a column is not indispensable. The control unit can also cause the processor 901 to execute addition, deletion, or update of a record in a specific table or master stored in the storage unit according to the various programs.

Note that the databases and masters in the present disclosure can include any data structure in which information is structurally defined (list, dictionary, associative array, object, etc.). It is assumed that the data structure includes data that can be regarded as a data structure in which data is combined with functions, classes, methods, and the like written in any programming language.

The communication unit is implemented by the communication IF 991. The communication unit implements a function of communicating with another computer 90 via a network. The communication unit can receive information transmitted from another computer 90 and input the information into the control unit. The control unit can cause the processor 901 to execute information processing on the received information according to the various programs. The communication unit can also transmit information output from the control unit to another computer 90.

### Supplements

The matters described in the embodiments described will be supplemented below.

### Supplement 1

A program to be executed by a computer including a processor and a storage unit, the program causing the processor to execute: a model accepting step (S102) of accepting a plurality of learned models selected by a user; and a generating step (S103, S107) of generating an information processing process by combining the plurality of learned models accepted in the model accepting step.

This enables the user to create a workflow flexibly and easily by combining the plurality of learned models.

### Supplement 2

The program according to Supplement 1, wherein the generating step (S103, S107) is a step that is capable of generating the information processing process including a combination in which output data of a first learned model included in the plurality of learned models serves as input data of a second learned model included in the plurality of learned models, and an output data constraint including an output data type and an output roll of the first learned model is included in an input data constraint including an input data type and an input roll of the second learned model.

This enables the user to create a workflow flexibly and easily by combining the plurality of learned models.

### Supplement 3

The program according to Supplement 2, wherein the generating step (S103, S107) is a step that is capable of generating the information processing process including a combination in which the output data of the first learned model included in the plurality of learned models serves as input data of a third learned model included in the plurality of learned models, and the first learned model selectively outputs the output data to any one of the second learned model and the third learned model such that an output data constraint of the output data output from the first learned model is included in an input data constraint of the second learned model or the third learned model.

This enables the user to create a workflow flexibly and easily by combining the plurality of learned models with a plurality of screens such as an input screen and notification screen.

### Supplement 4

The program according to Supplement 3, wherein the first learned model outputs the output data to the second learned model when the output data constraint of the output data output from the first learned model is included in the input data constraint of the second learned model, the first learned model does not output the output data to the second learned model when the output data constraint of the output data output from the first learned model is not included in the input data constraint of the second learned model, the first learned model outputs the output data to the third learned model when the output data constraint of the output data output from the first learned model is included in the input data constraint of the third learned model, and the first learned model does not output the output data to the third learned model when the output data constraint of the output data output from the first learned model is not included in the input data constraint of the third learned model.

When the user combines a plurality of learned models with an input screen, this sets input fields to the input screen in accordance with the output data types and output rolls of the learned models. Thus, it is possible to easily and flexibly create the input screen without complicated operations performed by the user.

### Supplement 5

The program according to any one of Supplements 1 to 4, wherein the program causes the processor to execute a screen accepting step (S106) of accepting a plurality of screens selected by the user, and the generating step (S107) is a step of generating the information processing process by combining the plurality of learned models accepted in the model accepting step and the plurality of screens accepted in the screen accepting step.

This enables the user to create a workflow flexibly and easily by combining the plurality of learned models with a plurality of functions.

### Supplement 7

The program according to any one of Supplements 1 to 6, wherein the program causes the processor to execute a function accepting step (S105) of accepting a plurality of functions selected by the user, and the generating step (S105) is a step of generating a workflow by combining the plurality of functions accepted in the function accepting step.

This enables the user to create a workflow flexibly and easily by selecting desired functions from among a plurality of functions presented to the user as a plurality of functions that can be combined with the learned models accepted in the accepting step.

### Supplement 8

The program according to Supplement 7, wherein the generating step (S105) is a step that is capable of generating the information processing process including a combination in which output data of the first learned model included in the plurality of learned models serves as input data of a first function included in the plurality of functions, and the output data type of the first learned model is included in an input data type of the first function.

This enables the user to create a workflow flexibly and easily by combining the plurality of learned models.

### Supplement 9

The program according to Supplement 7 or 8, wherein the program causes the processor to execute a presenting step (S104) of presenting, to the user, a plurality of functions that are selectable by the user, based on input data constraints including input data types and input rolls of the plurality of learned models accepted in the model accepting step or output data constraints including output data types and output rolls of the plurality of learned models, and the function accepting step (S105) is a step of accepting a plurality of functions selected by the user from among the plurality of functions selectable by the user that are presented in the presenting step.

This enables the user to create a workflow flexibly and easily by combining the plurality of learned models.

### Supplement 10

An information processing device including a processor and a storage unit, wherein the information processing device causes the processor to execute the program according to any one of Supplements 1 to 9.

This enables the user to create a workflow flexibly and easily by combining the plurality of learned models.

What is claimed is:

1. An information processing apparatus comprising:
processing circuitry configured to:
accept a plurality of learned models selected by a user; and
generate an information processing process by combining the plurality of learned models accepted.

2. The information processing apparatus according to claim 1, wherein
the processing circuitry generates the information processing process including a combination in which output data of a first learned model included in the plurality of learned models serves as input data of a second learned model included in the plurality of learned models, and
an output data constraint including an output data type and an output roll of the first learned model is included in an input data constraint including an input data type and an input roll of the second learned model.

3. The information processing apparatus according to claim 2, wherein
the processing circuitry generates the information processing process including a combination in which the output data of the first learned model included in the plurality of learned models serves as input data of a third learned model included in the plurality of learned models, and
the first learned model selectively outputs the output data to any one of the second learned model and the third learned model such that the output data constraint of the output data output from the first learned model is included in an input data constraint of the second learned model or the third learned model.

4. The information processing apparatus according to claim 3, wherein
the first learned model:
outputs the output data to the second learned model when the output data constraint of the output data output from the first learned model is included in the input data constraint of the second learned model;
does not output the output data to the second learned model when the output data constraint of the output data output from the first learned model is not included in the input data constraint of the second learned model;
outputs the output data to the third learned model when the output data constraint of the output data output from the first learned model is included in the input data constraint of the third learned model; and
does not output the output data to the third learned model when the output data constraint of the output data output from the first learned model is not included in the input data constraint of the third learned model.

5. The information processing apparatus according to claim 1, wherein
the processing circuitry accepts a plurality of screens selected by the user, and
generates the information processing process by combining the plurality of learned models accepted and the plurality of screens accepted.

6. The information processing apparatus according to claim 1, wherein
the processing circuitry generates the information processing process including a combination in which output data of a first screen included in the plurality of screens serves as input data of the first learned model included in the plurality of learned models; and
specifies, based on an input data constraint including an input data type and input roll of the first learned model, an input field included in a first input screen and a data constraint including a data type and roll of the input field.

7. The information processing apparatus according to claim 1, wherein
the processing circuitry accepts a plurality of functions selected by the user, and
generates a workflow by combining the plurality of functions accepted.

8. The program according to claim 7, wherein
the processing circuitry generates the information processing process including a combination in which output data of the first learned model included in the plurality of learned models serves as input data of a first function included in the plurality of functions, and
an output data type of the first learned model is included in an input data type of the first function.

9. The information processing apparatus according to claim 7, wherein
the processing circuitry presents, to the user, a plurality of functions that are selectable by the user, based on input data constraints including input data types and input rolls of the plurality of learned models accepted or output data constraints including output data types and output rolls of the plurality of learned models, and
accept a plurality of functions selected by the user from among the plurality of functions selectable by the user that are presented.

10. A non-transitory computer-readable storage medium, storing computer-readable instruction thereon, which, when executed by processing circuitry, cause the processing circuitry to execute a method comprising:
accepting a plurality of learned models selected by a user; and
generating an information processing process by combining the plurality of learned models accepted.

11. A method for operating a computer apparatus comprising processing circuitry, wherein the processing circuitry performs:
accepting a plurality of learned models selected by a user; and
generating an information processing process by combining the plurality of learned models accepted.
